(19) United States
(12) Patent Application Publication
(10) Pub. No.: US 2026/0053685 A1
(43) Pub. Date: Feb. 26, 2026

(54) ASSISTANCE DEVICE EQUIPPED WITH HANDLE AND MOVEMENT DEVICE USING SAME

(71) Applicant: Qolo Inc., Tsukuba-shi (JP)

(72) Inventor: Kai SASAKI, Tsukuba-shi (JP)

(21) Appl. No.: 19/103,022

(22) PCT Filed: Aug. 29, 2023
(86) PCT No.: PCT/JP2023/031345

§ 371 Date: Feb. 11, 2025

(30) Foreign Application Priority Data
Aug. 31, 2022 (JP) 2022138499

(51) Int. Cl. A61G 5/14

(52) U.S. Cl. CPC A61G 5/14

(57) ABSTRACT

A support equipment having a handle structure for supporting an upper body posture during the standing and sitting operations includes: a base; a first link fixed to the base; a second link rotatably connected to the first link; a slide base part fixed to the base at a position different from a position at which the first link is fixed to the base; and a third link having one end that is rotatably connected to the second link at a predetermined position, and another end that is slidably connected to the slide base part.

### TECHNICAL FIELD

The present invention relates to support equipment provided with handles, capable of executing a postural change, and moving equipment using the same.

### BACKGROUND ART

Standing and sitting operations are included in the activities of daily living, and are indispensable for sending daily life. Through performing the standing and sitting operations, the activities of daily life or social life such as walking action and excretion action can be independently performed. However, some people with congenital or acquired physical disabilities in lower limbs and some people with weakened physical functions due to aging are not capable of independently performing the standing and sitting operations. Thus, there is a demand for appropriate support equipment for supporting the standing and sitting operations for those people. If those people can perform the standing and sitting operations without relying on any caregiver or helper, a sphere of activity within which such a person can independently perform the activities of daily life is widened, and it contributes to the improvement of quality of life (QOL). Under such a background, devices for supporting the standing and sitting operations and the subsequent operations have been researched and developed.

In the cases of people with physical disabilities in lower limbs due to cerebral palsy, spinal cord injury, cerebral stroke or the like and of people with weakened physical functions due to aging, handles are oftentimes provided in the support equipment for supporting and stabilizing the upper body posture, in addition to supporting the lower limbs at the time of performing the standing and sitting operations. Under such a background, devices have been proposed which are provided with handles to be attached to a seat surface of a chair for supporting the upper body posture at the time of performing the standing and sitting operations (for example, see Patent Literature 1).

### CITATION LIST

### Patent Literature

[PTL 1] Japanese Patent No. 5672617

### SUMMARY

### Technical Problem

According to the Patent Document 1, the shape of the handle is devised such that the user can smoothly change the position at which the user grips the handle during the course of the postural change from the sitting posture to the standing posture. On the other hand, the user may need to finely adjust the handle position appropriately, and thus in the cases of people with spinal injury experiencing some paralysis in the trunk or the like, performing the positional adjustment of the hand during the standing and sitting operations may become difficult.

An object of the present invention is to provide a support equipment having a handle structure for supporting an upper body posture during the standing and sitting operations.

### Solution to Problem

In order to solve the above-mentioned problems, for example, the configurations described in the claims can be adopted.

The present application includes a plurality of means for solving the above-mentioned problems. For example, one embodiment includes: a base; a first link fixed to the base; a second link rotatably connected to the first link; a slide base part fixed to the base at a position different from a position at which the first link is fixed to the base; a third link having one end that is rotatably connected to the second link at a predetermined position, and another end that is slidably connected to the slide base portion; and a handle part fixed to the third link.

### Advantageous Effects

According to the present invention, it is possible to provide a support equipment having a handle structure for supporting an upper body posture during the standing and sitting operations.

### BRIEF DESCRIPTION OF DRAWINGS

FIG. 1 is a perspective view of a piece of support equipment according to one embodiment when in a sitting state.

FIG. 2 is a side view of a piece of support equipment according to one embodiment when in a sitting state.

FIG. 3 is a perspective view of a piece of support equipment according to one embodiment during the course of the postural change.

FIG. 4 is a side view of a piece of support equipment according to one embodiment during the course of the postural change.

FIG. 5 is a perspective view of a piece of support equipment according to one embodiment when in a standing state.

FIG. 6 is a side view of a piece of support equipment according to one embodiment when in a standing state.

FIG. 7 is a diagram illustrating the handle height during the course of the postural change.

FIG. 8 is a diagram illustrating numerical calculation results of the handle height during the course of the postural change for the case of using the present technology and for the case of using the conventional technology.

FIG. 9A is a side view of a piece of moving equipment using the support equipment according to one embodiment when in a sitting state.

FIG. 9B is a side view of a piece of moving equipment using the support equipment according to one embodiment when in a standing state.

FIG. 10 is a cross-sectional view taken along an X-X line in FIG. 1.

FIG. 11 is a side view of a piece of support equipment according to another embodiment.

FIG. 12 is a side view of a piece of support equipment according to another embodiment.

### DESCRIPTION OF EMBODIMENTS

### First Embodiment

In general, support equipment (hereinafter, the term “support equipment” is interchangeable with other similar variations such as “support device”) according to the present technology has a chair type form, and is capable of changing an inclination of its seat surface in association with a postural change of a user between a sitting posture and a standing posture. In addition, one or a plurality of handle parts are connected to the seat part to which the seat surface is provided. The present embodiment discloses support equipment capable of changing the position and the posture of the handle part in accordance with a change in the inclination of the seat surface.

Hereinafter, embodiments of the present invention will be described with referring to the figures. The following embodiments are examples for embodying the technical idea of the present invention, but the invention is not limited to the following configurations. In the figures, parts or members having the same function may be denoted by the same reference numerals, and redundant descriptions may be omitted.

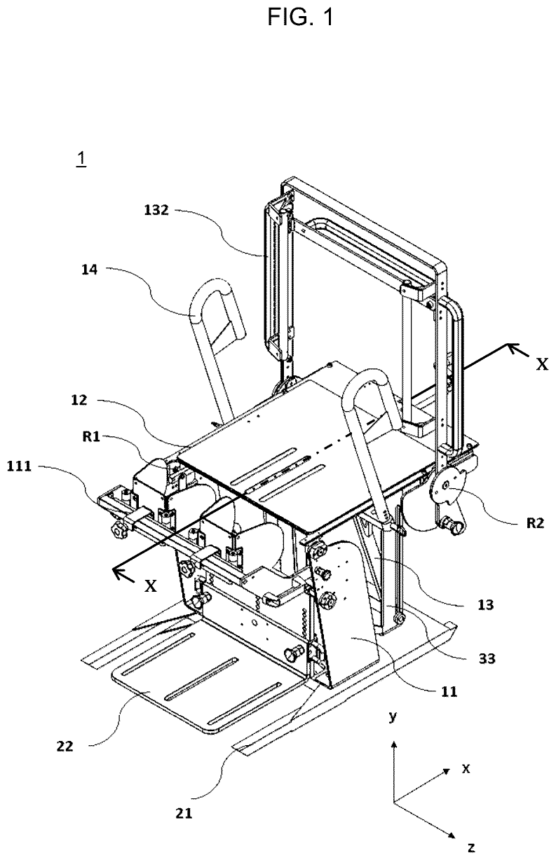

FIG. 1 is a perspective view of a piece of support equipment 1 according to one embodiment when in a sitting state.

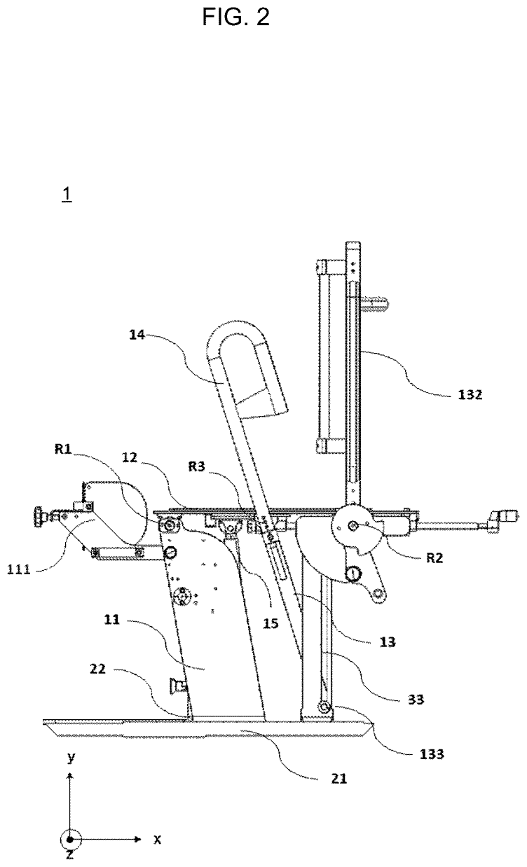

FIG. 2 is a side view of the support equipment 1 when in a sitting state.

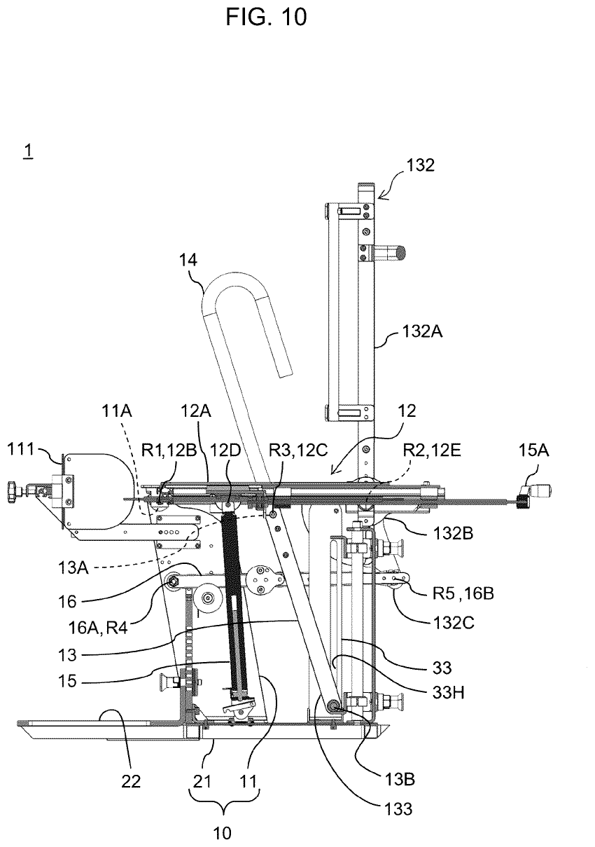

FIG. 10 is a cross-sectional view taken along an X-X line in FIG. 1.

In these figures, common coordinate axes are depicted. The front-rear direction of the support equipment 1 is made to be the x-axis, the vertical (or height) direction thereof is made to be the y-axis, and the width direction thereof is made to be the z-axis. The x-y plane is defined as a sagittal plane. The front side is the direction in which the user sitting on the support equipment 1 faces, and the width direction is the left-right direction of the user sitting on the support equipment 1.

The support equipment 1 includes:
a base 21;
a first link 11 fixed to the base 21;
a second link 12 rotatably connected to the first link 11;
a slide base part 33 fixed to the base 21;
a third link 13 having one end that is rotatably connected to the second link and the other end that is slidably connected to the slide base part in a uniaxial direction; and
a handle part 14 fixed to the third link so as to be held or gripped by the user.

According to the present embodiment, the main body part 10 (see FIG. 10) includes the base 21 and the first link 11 of the present embodiment. The main body part 10 is a configuration element for rotatably connecting the second link 12.

The second link 12 is a configuration element for constituting a seat part on which a user is allowed to sit on the support equipment 1. The second link 12 is one example of the seat part of the present technology. The second link 12 of the present embodiment has a generally rectangular plate-shaped body when viewed in a plan view. The second link 12 is disposed such that the respective sides of the rectangular shape are made to extend in the front-rear direction and the width direction (or the lateral direction on the left and right sides) in a sitting state.

Bearing portions 12B for receiving a pair of first shaft portions 11A, which will be described later, are provided at the lower front side of the second link 12. A connecting portion 12D for connecting a passive actuator 15, which will be described later, is provided backward from the bearing portions 12B of the second link 12. In addition, connecting shaft portions 12C for connecting the third links 13 are provided backward from the bearing portions 12B of the second link 12. Further, connecting portions 12E for connecting a backrest 132, which will be described later, are provided backward from the connecting shaft portions 12C, on both side surfaces of the second link 12.

The bearing portions 12B and the connecting shaft portions 12C are composed, respectively, as a pair of left and right side parts along the width direction of the second link 12. Hereinafter, an axis along which the bearing portions 12B are received is referred to as a center of rotation R1, an axis formed by the connection shaft portions 12C is referred to as a center of rotation R3, and an axis formed by the connection portions 12E is referred to as a center of rotation R2.

The second link 12 has a seat surface 12A. The second link 12 is supported by the main body part 10 so as to bring the seat surface 12A to level when it is in a sitting state.

The shape of the second link 12 of the present embodiment is generally rectangular, but the shape of the second link 12 is not limited thereto. For example, the shape of the second link 12 may be a circular, a trapezoidal, or the like. In addition, the seat surface 12A of the second link 12 is illustrated to be flat, for convenience of explanation, but the shape of the seat surface 12A is not limited thereto. For example, the seat surface 12A may have a configuration corresponding to buttocks of the user such that the user can sit thereon without having an uncomfortable feeling. Further, the seat surface 12A of the second link 12 may be provided with, for example, a cushion or the like for realizing a more comfortable feeling when the user sits on it.

The base 21 is configured by assembling leg portions extending in the front-rear direction to left and right ends of a rectangular plate-shaped body. The base 21 supports the entire support equipment 1. The first link 11 and the slide base part 33 are fixed to the upper surface of the base 21.

The first link 11 is a configuration element for supporting the front side of the second link 12. The first link 11 includes two pieces of plate-shaped support parts and a pair of first shaft portions 11A. The two pieces of support parts are arranged on the base 21 apart from one another in the width direction. A pair of the first shaft portions 11A are arranged so as to be coaxial along the width direction at upper ends of opposing surfaces of these support parts. The second link 12 is rotatably connected to the first link 11 about the first shaft portions 11A by attaching the respective first shaft portions 11A to the corresponding bearing portions 12B of the second link 12.

The slide base part 33 is a configuration element for restricting movement of the third link 13. The slide base part 33 is one example of a restricting part of the present technology. Also, the slide base part 33 has a function of controlling the posture of the handle part 14 by combining it with the third link 13.

The slide base part 33 has a generally rectangular cylindrical shape or frame shape, and its bottom surface portion is disposed on the base 21 so as to open in the front-rear direction. An elongated hole 33H is provided on each of a pair of side surfaces of the slide base part 33. The elongated hole 33H is a guide hole for guiding a moving position of an engagement portion 13B of the third link 13, which will be described later. In the present embodiment, the elongated hole 33H has a straight shape extending vertically (or straightly in the up-down direction).

The handle part 14 is a configuration element for being held or gripped by the user's hand. In the present embodiment, two pieces of handle parts 14 are provided, one for a right hand and the other for a left hand. Each handle part 14 is constituted by a generally U-shaped or J-shaped cylindrical member, and one end thereof is connected to the third link 13. For example, a main gripping portion of the handle part 14 may be formed to extend from a semi-circular bent portion to an end on a side not connected to the third link 13, but the shape of the handle part 14 is not restricted to this example. For example, an end of the handle part 14 on a side connected to the third link 13 is provided with connecting portions at a plurality of positions along the longitudinal direction thereof, such that the length of the handle part 14, in other words, the position of the gripping portion is capable of being finely adjusted.

The third link 13 is a configuration element for rotatably connecting the handle part 14 to the second link 12. Also, the third link 13 has a function of controlling the posture of the handle part 14 by being combined with the slide base part 33. The third link 13 is provided for each handle part 14. The third link 13 includes an elongated plate-shaped link body, a connecting hole portion 13A provided at one end of the link body, and an engagement portion 13B provided at the other end 133 of the link body.

The third link 13 is connected to the handle part 14 at one end thereof. In this embodiment, the third link 13 is connected to the handle part 14 via a connecting member provided in the vicinity of the connecting hole portion 13A. The link body of the present embodiment has a linear shape. The third link 13 is connected to a cylindrical member of the handle part 14 on a side connected to the third link 13 to form a straight line when viewed in a side view.

The third link 13 is rotatably connected to the second link 12 by attaching the connection shaft portion 12C of the second link 12 to the connection hole portion 13A. In the present embodiment, the connecting hole portion 13A is provided such that a distance from a gripping portion of the handle part 14 (for example, a position of the handle part 14 where a distance from the third link 13 is the largest) to the connecting hole portion 13A is made to be smaller than a distance from the engagement portion 13B to the connecting hole portion 13A. However, the position of the connecting hole portion 13A is not limited to this example.

The engagement portion 13B is detachably provided at the other end 133 of the link body. The engagement portion 13B protrudes outwardly from the front surface of the link body in the width direction when the engagement portion 13B is attached to the link body. The engagement portion 13B includes a base portion close to the link body and a head portion to be connected to the base portion. The diameter of the base portion is made to be smaller than the width of the elongated hole 33H of the slide base part 33, and the diameter of the head portion is made to be larger than the width of the elongated hole 33H of the slide base part 33. Accordingly, when the engagement portion 13B is attached to the link body in a condition that the base portion is inserted into the elongated hole 33H, the third link 13 is engaged with the slide base part 33 at the other end 133. The other end 133 of the third link 13 is capable of moving along the elongated hole 33H of the slide base part 33. In other words, the other end 133 of the third link 13 is capable of moving in the up-down direction in accordance with the shape of the elongated hole 33H, and the other movement (for example, movement in the front-rear direction) is restricted.

A passive actuator 15 is provided between the second link 12 and the base 21. The passive actuator 15 is a configuration element for making a transition (or change) of the support equipment 1 from the sitting state to the standing state. For example, the passive actuator 15 rotates the second link 12 in the sitting state upward about the center of rotation R1. In the present embodiment, as the passive actuator 15, a total of three pieces of gas springs of one type having a locking function and two types having no locking function are arranged in the width direction. Each gas spring is rotationally connected to both of the second link 12 and the base 21. The gas spring in the middle of the three pieces has a built-in locking mechanism such that the extension of the gas spring is able to be locked in an arbitrary position. A lever 15A for operating the locking mechanism is connected to the gas spring in the middle of the three pieces such that the locking of the passive actuator 15 is able to be released by operating the lever 15A.

When in the sitting state, the seat surface 12A of the second link 12 is in a posture which is substantially parallel to the base 21. Here, the “substantially parallel” or “substantially perpendicular” does not necessarily mean an angle of exactly 0 degree or 90° with respect to the base, but can mean an angle having a degree of freedom in design of approximately ±30° depending on the situations of daily life and the use states such as the rehabilitation state, working state, and the like, and for example, it can mean an angle having a degree of freedom in design of approximately ±10°. When the second link 12 is in a posture generally parallel to the base 21, it corresponds to the sitting posture of the support equipment 1. Also, when the second link is generally perpendicular to the base 21, it corresponds to the standing posture of the support equipment 1.

The main body part 10 may be provided with a footrest 22. In addition, the main body part 10 may be provided with a knee rest 111. Further, a backrest 132 may be coupled to the second link so as to be rotatable. The footrest 22, the knee rest 111, and the backrest 132 are not essential elements of the present invention, but may be required to enhance the safety, stability, and comfort of the user.

The footrest 22 is a configuration element for supporting both legs of the user from below. The footrest 22 is a rectangular plate-shaped member extending forward, at the lower side of the second link 12. For example, the footrest 22 may be attached to the base 21 or the first link 11 so as to be capable of relatively changing the height with respect to the second link 12.

The knee rest 111 is a stopper for restricting the forward movement of the user's knees so as to ensure that the knees are not collapsed when the user stands up. The knee rests 111 are provided in a pair of left and right sides in the upper front of the second link 12 in the sitting posture and also are slightly ahead of the knees of the user in the standing posture. The knee rests 111 may be provided on the first link 11, for example, so as to be detachable or displaceable.

The backrest 132 is a configuration element for supporting the weight of the user's upper body moved backward when the user in the sitting posture moves the upper body backward. Also, the backrest 132 is configured to restrict the backward movement of the user's upper body.

The backrest 132 includes a back plate, a linkage frame 132A, and a backrest support mechanism 16. The back plate has a generally rectangular plate body. In the figures, the representation of the back plate is omitted. The linkage frame 132A is a frame-shaped member for supporting the back plate. The linkage frame 132A is configured to have a larger height dimension as comparing to the back plate, and includes a linkage portion 132B for linking the second link 12 below a part for supporting the back plate, and a linkage portion 132C for linking the backrest support mechanism 16 below the linkage portion 132B. The linkage frame 132A is rotatably connected to the second link 12 at the linkage portion 132B. In addition, the linkage frame 132A is rotatably connected to the backrest support mechanism 16 at the linkage portion 132C.

The backrest support mechanism 16 is a configuration element for adjusting the linkage frame 132A such that the linkage frame 132A is brought in a predetermined posture (for example, the back plate is made to be vertical). The backrest support mechanism 16 is provided as a pair of left and right side parts along the width direction so as to be connected to both side surfaces of the linkage frame 132A. The backrest support mechanism 16 is a rod-shaped member, and includes one end where a linkage portion 16A is provided for linking the main body part 10 and the other end where a linkage portion 16B is provided for linking the linkage frame 132A. For example, the backrest support mechanism 16 is rotatably connected to the first link 11 of the main body part 10 at the linkage portion 16A. Also, for example, the backrest support mechanism 16 is rotatably connected to the linkage frame 132A at the linkage portion 16B. The linkage portion 16A forms a center of rotation R4 of the backrest support mechanism 16 with respect to the main body part 10, and the linkage portion 16B forms a center of rotation R5 between the backrest 132 and the backrest support mechanism 16. Here, the position of the linkage portion 16A and that of the linkage portion 16B are adjusted such that the respective center of rotations R1, R2, R4, and R5 form a parallelogram shape.

The second link 12 is rotatable about the center of rotation R1 with respect to the fixed first link 11. The rotation at the center of rotation R1 corresponds to the rotation at knee joints of the user. The rotation of the second link 12 about the center of rotation R1 corresponds to the movement of the user's thighs at the time of extending and bending the user's knees. The backrest 132 is rotatable about the center of rotation R2 with respect to the second link 12. The rotation at the center of rotation R2 corresponds to the rotation at hip joints of the user. The rotation of the backrest 132 about the center of rotation R2 corresponds to the postural change of the user's upper body when the user changes the posture.

The second link 12 is connected to the slide base part 33 through the third link 13. The third link 13 is connected to the second link 12 so as to be rotatable around the center of rotation R3, and is connected to the slide base part 33 so as to be slidable in a uniaxial direction. In the example of FIGS. 1 and 2, the slide base part 33 is a bent sheet metal component provided with machined, elongated holes each on both side surfaces thereof. The elongated hole of the slide base part 33 does not necessarily have to be machined in a direction perpendicular to the base 21. The elongated hole may be machined to be inclined forward or backward with respect to the base 21 as long as the second link 12 is movable to the standing posture. Further, without being restricted to an elongated hole, it is possible to use a slide rail or the like, as long as the third link 13 is slidable.

The rotation of the second link 12 with respect to the first link 11 may be performed without being powered by a power source such as a motor or a battery. On the other hand, the rotation of the second link 12 with respect to the first link 11 may be performed, for example, by using a passive actuator 15 using elastic force, but this is not required. As examples of the passive actuator 15, there are a compression spring, a gas spring, a viscoelastic damper using hydraulic pressure, a coil spring, and the like. When a load moment acting on the center of rotation R1 is changed due to the postural change in the user's upper body, the passive actuator 15 starts to rotate the second link 12 while exerting a support moment corresponding to the posture of the second link 12.

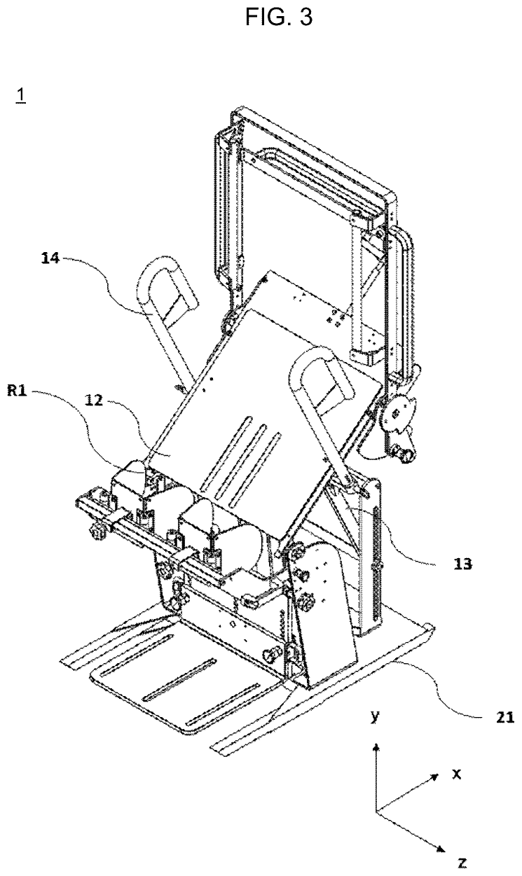

Subsequently, making a transition from the sitting state to the standing state will be described with referring to FIGS. 3 to 6 and 10, as appropriate.

Firstly, the user of the support equipment 1 (the user may be a caregiver or helper) operates the lever 15A to unlock the passive actuator 15 in order to make a transition from the sitting posture to the standing posture. Then, the passive actuator 15 in the contracted condition at the sitting state starts to extend to press the second link 12 upward.

When the user inclines the user's upper body forward in this condition, a load moment which is applied to the second link 12 around the user's knees (or center of rotation R1) is reduced, and the second link 12 starts to rotate upward around the center of rotation R1.

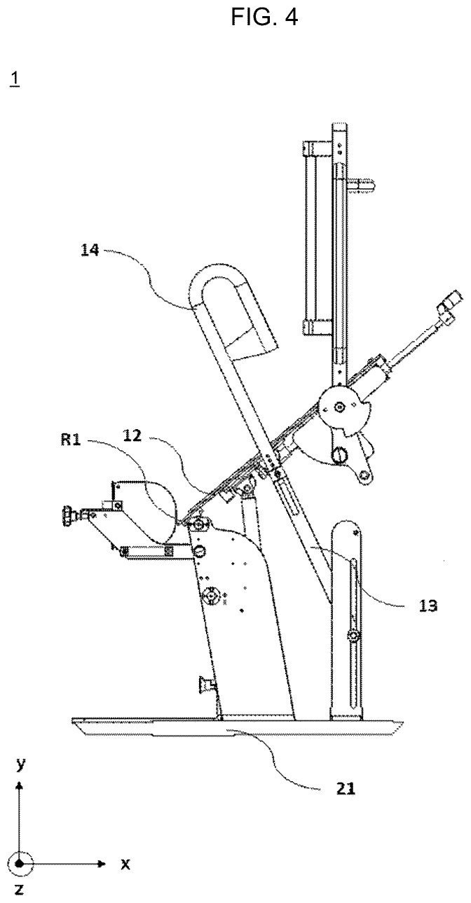

FIG. 3 is a perspective view of the support equipment 1 of the present embodiment during the course of the postural change, and FIG. 4 is a side view of the support equipment 1 during the course of the postural change. When the sitting position illustrated in FIGS. 1 and 2 is changed toward the standing position, the second link 12 rotates counterclockwise about the center of rotation R1 and rises up from a position generally horizontal to the base 21 toward a normal line of the seat surface 12A of the second link 12.

The center of rotation R3 between the second link 12 and the third link 13 also moves in an arc shape upward around the center of rotation R1. The handle part 14 is connected to the second link 12 via the third link 13. Accordingly, the handle part 14 is made to move in an arc shape upward as a whole, in other words, it is made to move toward a front upper direction.

In a case when the handle part 14 is fixedly connected to the second link 12 without being able to rotate, as occurred in the conventional technology, the gripping portion of the handle part 14 positioned above with respect to the second link 12 (in other words, forward in the rising direction which is directed from the sitting state to the standing state) is rotated to an angle larger than the second link 12 on the basis of the center of rotation R1. As a result, the gripping portion of the handle part 14 moves upward and forward, and then moves downward and forward.

In contrast, in the present technology, the third link 13 is interposed between the handle part 14 and the second link 12, and the movement of the other end 133 of the third link 13 is restricted by the slide base part 33. Consequently, when the center of rotation R3 moves forward in association with the transition from the sitting position toward the standing position, the third link 13 is rotated around the center of rotation R3 in a direction opposite to the rotational direction of the second link 12 because the movement of the other end 133 in the front-rear direction is restricted.

Then, the gripping portion of the handle part 14 is moved around the center of rotation R3 in a direction opposite to the rotational direction of the second link 12.

As a result, the trajectory of the gripping portion of the handle part 14 with respect to the center of rotation R1 is formed by combining the movement of the center of rotation R3 with respect to the center of rotation R1 and the movement of the gripping portion with respect to the center of rotation R3. As a consequence, the upward movement of the gripping portion of the handle part 14 on the basis of the center of rotation R1 is increased, and the subsequent downward movement is suppressed to be small, as compared with the case when the handle part 14 is fixedly connected to the second link 12. When the sitting posture is changed to the standing posture, the height of the user's elbow is increased, but the position of the gripping portion is not significantly decreased even when approaching the standing posture so that it is possible to move the gripping portion within a range such that the gripping portion can be easily held by the user In summary, the third link 13 rotates clockwise with respect to the center of rotation R3 in association with the rising up of the second link 12. In accordance with this movement, the handle part 14 fixed to the third link 13 is moved such that the handle position is heightened, in a direction from the front side to the rear side of the seat surface. This makes it possible to move the handle part so as to be easily held by the user in any posture in a range from the sitting posture to the standing posture.

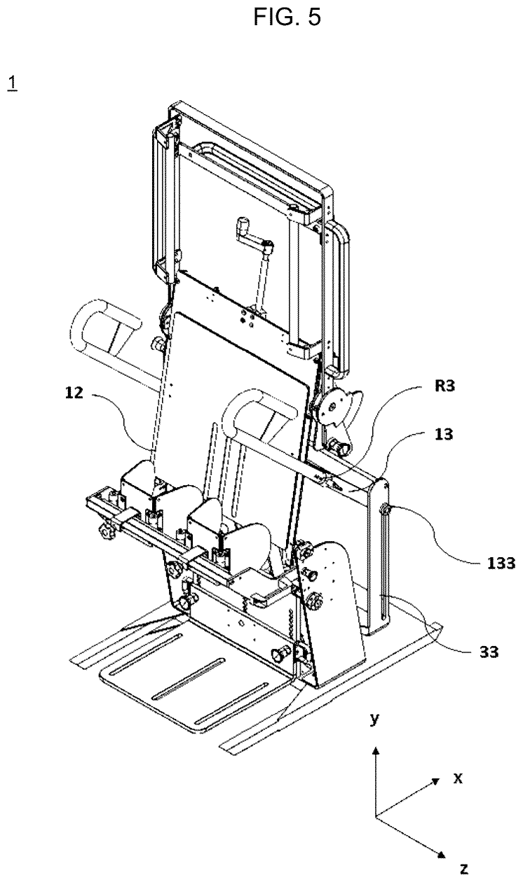

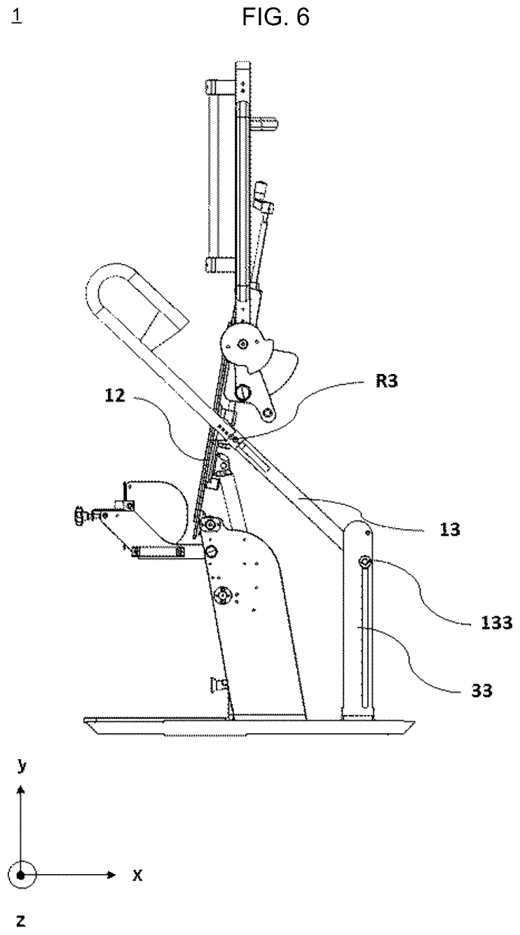

FIG. 5 is a perspective view of the support equipment 1 according to the embodiment in the standing state, and FIG. 6 is a side view of the support equipment 1 in the standing state. In the standing state, the second link 12 rises up at an angle of approximately 80°±10°, which is generally vertical. The angle of the second link 12 in the standing state may be changed on the basis of 80°, depending on the use states such as the states regarding rehabilitation, working, and the like. This angle of the second link 12 corresponds to the knee angle of the user so that it is desirable to use it at 90°or less in order to suppress excessive extension of the knee.

The maximum angle for rotating the second link 12 may be controlled, for example, by appropriately adjusting the length of the third link 13 (or a distance between the center of rotation R3 and the engagement portion 13B) and the shape of the elongated hole 33H of the slide base part (or the highest position of the elongated hole 33H).

When the transition from the sitting posture to the standing posture is completed, the user operates the lever 15A to lock the extending/contracting operation of the passive actuator 15 as necessary.

With respect to the position and the posture of the handle part 14 illustrated in FIGS. 1, 2, the handle part 14 extends in a direction from the center of rotation R3 toward the center of rotation R1. On the other hand, in FIGS. 5, 6, the handle part 14 extends in a direction from the center of rotation R3 toward the center of rotation R2. That is, as the second link 12 rises up, the handle part 14 rotates from the front side to the rear side of the seat surface 12A, and the handle position is made to be heightened. This is because the end of the third link 13 to which the handle part 14 is connected is rotatably connected to the second link 12 around the center of rotation R3, and the other end 133 of the third link 13 is slidably connected to the slide base part 33. The third link 13 is capable of performing the rotational movement relative to the second link 12 in association with the rotational movement of the second link 12 so that the handle part can be moved to be easily held in any posture.

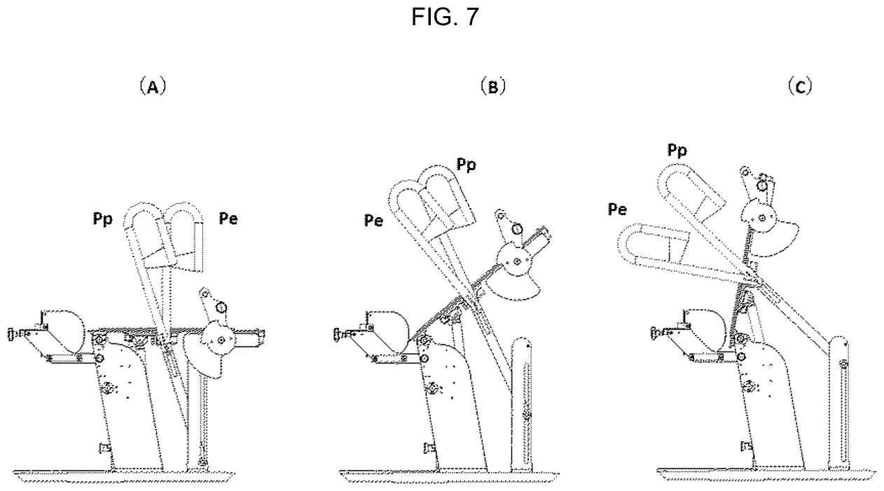

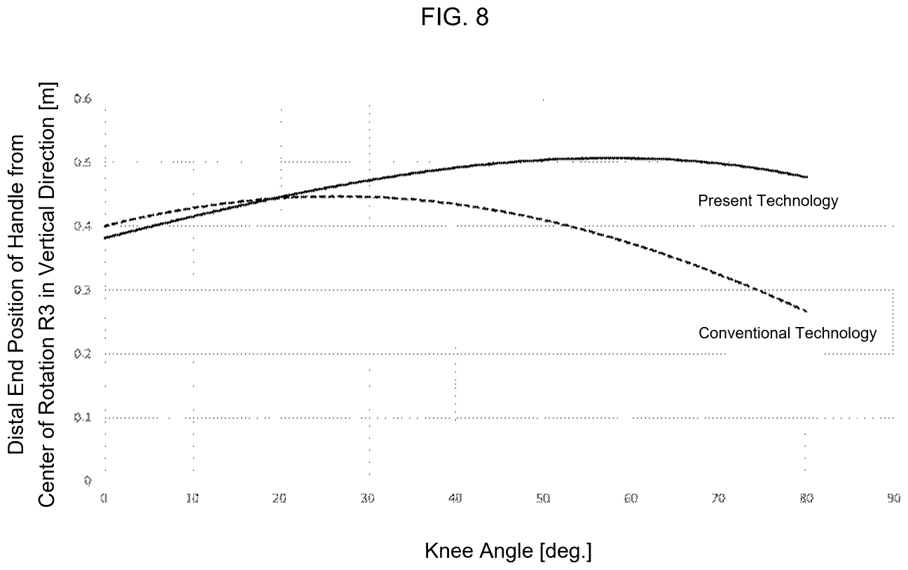

FIG. 7 is a diagram giving a comparative example of the transition of the handle position Pp according to the present technique, and of the transition of the handle position Pe when the handle part is directly connected to the second link 12, as occurred in the conventional technology, during the standing and sitting operations. It is assumed that the origins of both handles are made to be the same center of rotation R3, and the lengths from the center of rotation R3 to the handle tips are made to be equal. In the case of the conventional technology, the handle does not rotate relative to the center of rotation R3 and is stationary. FIG. 8 is a diagram giving numerical calculation results of the handle positions illustrated in FIG. 7. In FIG. 8, the horizontal axis indicates the knee angles (extension angles from the sitting position), and the vertical axis indicates the handle heights. On the horizontal axis, the sitting posture corresponds to 0 degree and the standing posture corresponds to 80°, respectively. As illustrated in FIGS. 7, 8, the handle part can be positioned at higher positions in the structure of the present technology, in especially, approaching to the standing posture, and thereby, the standing and sitting operations can be performed while stabilizing the upper body.

Referring again to FIGS. 1 to 6 and 10, the transition from the standing state to the sitting state will be described.

In a case where the passive actuator 15 is locked, the user of the support equipment 1 operates the lever 15A to release the extending/contracting operation of the passive actuator 15. Then, the passive actuator 15 starts to press the second link 12 of which upward rotation is restricted toward the upward direction.

When the user inclines the user's upper body backward to sit down in this condition, a load moment around the knees (or center of rotation R1) is increased, and a downward load is applied to the passive actuator 15. When the magnitude of the load exceeds the pressing force of the passive actuator 15, the passive actuator 15 is contracted in the downward direction.

When the passive actuator 15 contracts, the second link 12 rotates downward around the center of rotation R1. In accordance with this movement, the center of rotation R3 moves in an arc shape downward around the center of rotation R1, and also the third link 13 and the handle part 14 move in an arc shape downward around the center of rotation R1 as a whole.

Here, the movement of the other end 133 of the third link 13 is restricted by the slide base part 33. Consequently, the other end 133 of the third link 13 is restricted from moving in the front-rear direction, and rotates in a direction opposite to the rotational direction of the second link 12 around the center of rotation R3. Then, the gripping portion of the handle part 14 is moved around the center of rotation R3 in a direction opposite to the rotational direction of the second link 12.

Therefore, the trajectory of the gripping portion of the handle part 14 with respect to the center of rotation R1 is formed by combining the movement of the center of rotation R3 with respect to the center of rotation R1 and the movement of the gripping portion with respect to the center of rotation R3. As a result, the gripping portion of the handle part 14 moves downward from a higher position with respect to the center of rotation R1, more calmly as compared with a case where the handle part 14 is fixedly connected to the second link 12.

At the initial stage of the transition from the standing posture toward the sitting posture, the user tilts the upper body backward. According to the present technology, the position of the gripping portion is not moved greatly at this stage. Therefore, the gripping portion is moved within a range such that the gripping portion can be easily held by the user.

When the transition from the standing posture to the sitting posture is completed, the user operates the lever 15A to lock the extending/contracting operation of the passive actuator 15.

With respect to the backrest 132, the positions of the center of rotations R2, R5 are changed during the course of the postural change between the standing position and the sitting position. In this case, the center of rotation R5 is positioned by the backrest support mechanism 16 with respect to the center of rotation R2 such that the respective center of rotations R1, R2, R5, and R4 form a parallelogram shape. Therefore, the backrest 132 is capable of always maintaining the predetermined posture during the course of the postural change between the standing position and the sitting position.

The postural change of the support equipment 1 has been described above.

The support equipment 1 described above includes:
the main body part 10;
the second link 12 (seat part) which is provided with a seat surface 12A, and is rotatably provided with respect to the main body part about a first axis extending laterally at a front side of the second link 12;
the third link 13 (link part) which is connected to the second link 12 such that the third link can rotate about a second axis arranged behind the first axis, at a side of the second link 12;
the handle part 14 which is connected to the one end of the third link 13; and
the slide base part 33 (restricting part) for restricting movement of the other end 133 of the third link 13 to a predetermined range.

According to the support equipment 1 constituted by this manner, the movement of the handle part 14 is suppressed during the course of the rotation of the second link 12. As a result, for example, the user may not be required to finely re-hold the handle part 14 and accordingly, it is possible to further stabilize the user's upper body.

According to the support equipment 1 described above, the seat part is configured to be movable between a first position in which the seat surface is made to be horizontal and a second position in which the rear side of the seat surface is made to be rotated by a predetermined angle toward the upper side from the first position. For example, the postural change is enabled between the sitting state and the standing state. Therefore, it is possible to suppress the movement of the handle part 14 when the posture of the user is changed between the sitting position and the standing position.

According to the support equipment 1 described above, the restricting part is configured to restrict the movement of the above-mentioned other end by making the handle part move along a predetermined trajectory. As a result, for example, when the posture of the user is changed between the sitting position and the standing position, the gripping portion of the handle part is made to be moved along a trajectory by which the user can easily hold the gripping portion.

Therefore, the user's upper body may be more easily stabilized at the time of performing the standing and sitting operations.

According to the support equipment 1 described above, the restricting part is configured to allow the movement of the above-mentioned other end of the link part in the vertical direction and to restrict the movement thereof in the front-rear direction. Accordingly, it is possible to effectively suppress the downward movement of the handle part 14 when the sitting position is changed toward the standing position, and in particular, to effectively suppress the downward movement of the handle part 14 immediately before the transition to the standing position. As a result, it becomes possible to maintain the handle part 14 at a relatively high position.

### Application to Moving Equipment

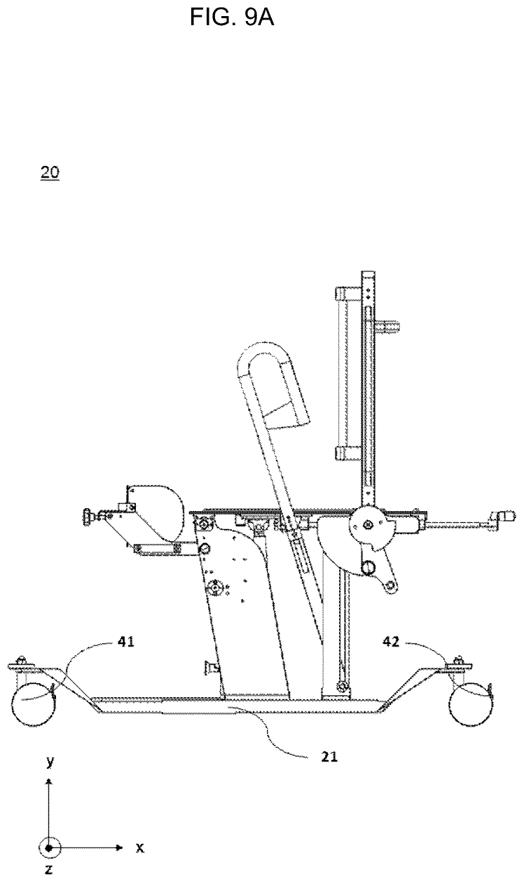

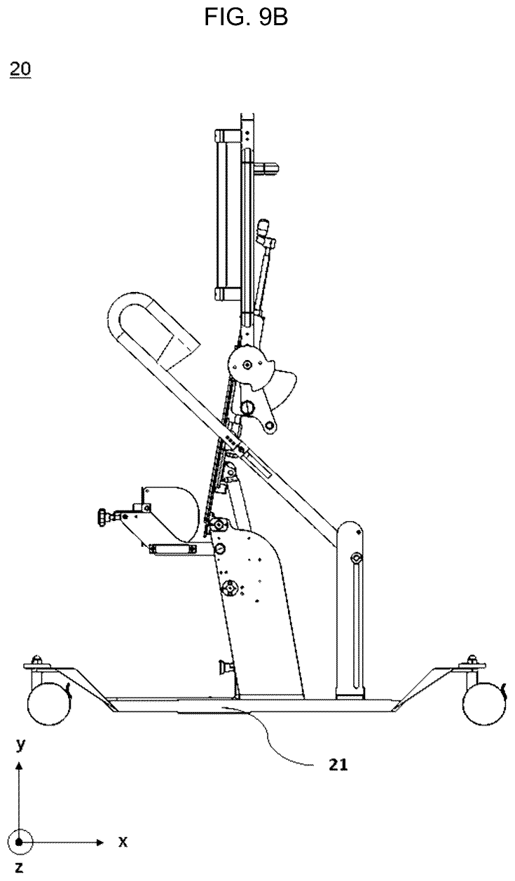

FIG. 9A is a side view of a piece of moving equipment (hereinafter, the term “moving equipment” is interchangeable with other similar variations such as “moving device” and “movable device”) 20 using the support equipment 1 when in the sitting posture.

FIG. 9B is a side view of the moving equipment using the support equipment 1 when in the standing posture.

The configuration of the support equipment 1 is the same as that illustrated in FIGS. 1 to 6. The moving equipment 20 is provided with casters 41, 42 to be attached to the base 21 of the support equipment 1. The caster 41 may be attached to the front side of the base 21, and the caster 42 may be attached to the rear side of the base 21. Instead of the casters 41 and 42, it is possible to use a combination of electrically driven wheels and a drive control device in the support equipment 1. The types of the wheels for performing movement are not restricted, and the wheels may be re-arranged according to the moving environment and the use states.

The moving equipment 20 may be provided with a stopper to enable the user to safely perform the standing and sitting operations. For example, casters capable of simultaneously fixing the rotation and the turn of wheels are used in the embodiment. This makes it possible to move to an arbitrary position and fix the position at that place. The moving equipment 20 may be used as a wheelchair or a rehabilitation device in homes, offices, hospital facilities, etc., and may also be used as a chair that can be used with general desks and standing type desks. The moving equipment 20 may also be used as work support equipment in factory facilities in which a sitting position, a standing position, and an intermediate posture therebetween may be frequently taken.

### Second Embodiment

According to the present embodiment, the support equipment includes:
a main body part;
a seat part which is provided with a seat surface, and is provided to the main body part such that the seat part can rotate about a first axis extending in a width direction (or laterally) at a front side of the seat part;
a link part which is provided to the seat part such that the link part can rotate about a second axis extending in parallel with the first axis, arranged behind the first axis, at a side of the seat part;
a handle part provided to one end of the link part; and
a restricting part provided to the main body part so as to restrict movement of another end of the link part to a predetermined range.

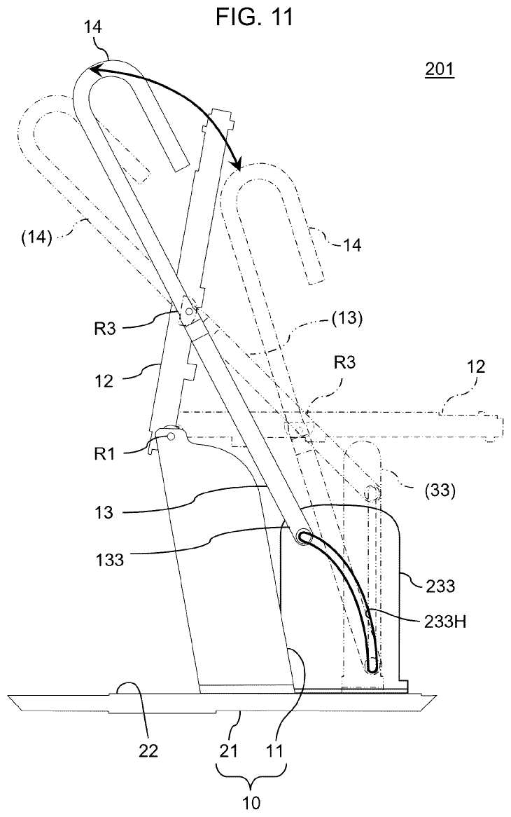

FIG. 11 is a side view of the support equipment 201 according to the second embodiment.

The support equipment 201 according to the second embodiment is distinguished from the first embodiment with respect to the shape of a slide base part 233 (which is one example of the restricting part) and that of an elongated hole 233H. The support equipment 201 of the second embodiment may be the same as the support equipment 1 of the first embodiment in other respects, and descriptions of the overlapping configurations and operational effects will be omitted.

FIG. 11 illustrates a simplified structure of the support equipment 201. In FIG. 11, the second link 12, the third link 13, and the handle part 14 in the sitting state are depicted by dashed lines, and the second link 12, the third link 13, and the handle part 14 in the standing state are depicted by solid lines. In addition, the slide base part (33), the third link (13) and the handle part (14) in the standing state according to the first embodiment are depicted by two-dot lines, for reference.

The slide base part 233 of the present embodiment is provided with a curved elongated hole 233H. The elongated hole 233H is shaped to extend from the rear side to the front side as progressing to the upper side from the lower side. Further, the elongated hole 233H is curved so as to have an upward projecting shape (or upward convex shape).

The trajectory of movement of the handle part 14 by the support equipment 201 will be discussed on the basis of the case when the sitting position is changed to the standing position.

The second link 12 and the center of rotation R3 are made to move in an arc shape upward around the center of rotation R1, and the other end 133 of the third link 13 is made to move along the elongated hole 233H having the upward projecting shape. The trajectory of the center of rotation R3 and that of the other end 133 of the third link 13 are similar with each other so that the handle part 14 is capable of moving more smoothly as compared with the case of the first embodiment, while suppressing the variation of the posture of the handle part 14.

In addition, the end point (front upper end) of the elongated hole 233H is positioned forward and downward from the elongated hole 33H of the first embodiment so that the distal end (the farthest point from the center of rotation R3) of the handle part 14 at the standing position is positioned rearward and upward in comparison with the case of the first embodiment. Accordingly, for example, as illustrated in FIG. 8, it is capable of suppressing lowering of height of the handle part (14) of the first embodiment when approaching the standing state. As a result, it is possible to suppress lowering of height of the gripping portion of the handle part 14, for example, at a position closer to the standing position, and to maintain it at a relatively high position.

### Third Embodiment

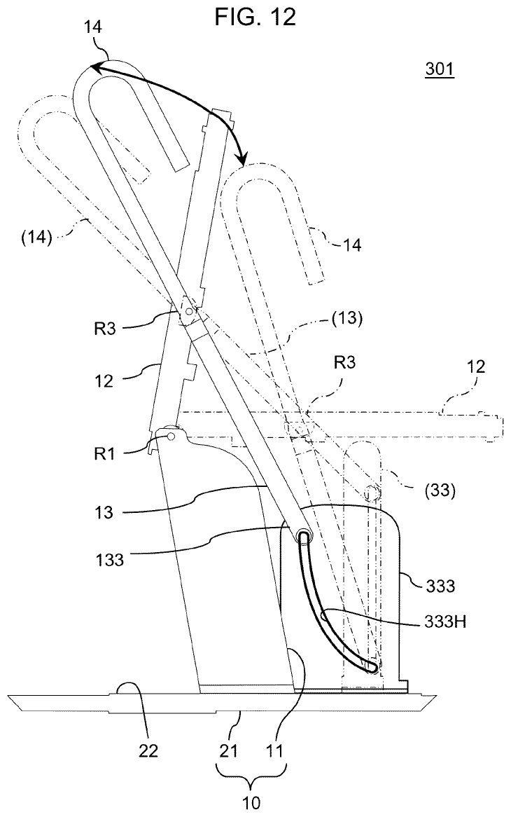

FIG. 12 is a side view of the support equipment 301 according to the third embodiment.

The support equipment 301 according to the third embodiment is distinguished from the first embodiment and the second embodiment with respect to the shape of an elongated hole 333H of a slide base part 333 (which is one example of the restricting part). The support equipment 301 of the third embodiment may be the same as the support equipment 1, 201 of the first embodiment and the second embodiment in other respects, and descriptions of the overlapping configurations and operational effects will be omitted.

FIG. 12 illustrates a simplified structure of the support equipment 301. The second link 12, the third link 13, and the handle part 14 in the sitting state are depicted by dashed lines, and the second link 12, the third link 13, and the handle part 14 in the standing state are depicted by solid lines. In addition, the slide base part (33), the third link (13) and the handle part (14) in the standing state in the first embodiment are depicted by two-dot lines, for reference.

The slide base part 333 of the present embodiment is provided with a curved elongated hole 333H. The elongated hole 333H is shaped to extend from the rear side to the front side as progressing to the upper side from the lower side. The start point and the end point of the elongated hole 333H are the same of those of the elongated hole 233H of the second embodiment. However, the elongated hole 333H is curved so as to have a downward projecting shape (or downward convex shape).

In the case of the support equipment 301, the positions and the postures of the handle part 14 at the sitting state and the standing state are the same of those of the support equipment 201 of the second embodiment. However, at the initial stage during which the standing posture is changed toward the sitting posture, the upward movement of the other end 133 of the third link 13 is relatively regulated and it is moved further forward as compared with the case of the second embodiment.

According to the trajectory of the gripping portion of the handle part 14 constituted in this manner, the movement to the upward direction becomes large at the initial stage during which the second link 12 is moved from the sitting position toward the standing position. Such movement of the gripping portion of the handle part 14 may help to put the upper body inclined forward back at the initial stage during which the sitting posture is changed toward the standing posture.

Also, it is possible to suppress lowering of height of the gripping portion of the handle part 14 at a position closer to the standing position, and to maintain it at a relatively high position, as in the case of the second embodiment.

The present invention has been described based on the specific configuration examples, but the present invention is not limited to the above-mentioned configuration examples. For example, the slide base part does not necessarily have to use a component to which an elongated hole is machined in the vertical direction. Instead of using an elongated hole, the slide base part may be configured to be slidably movable with a slide rail. Also, the slide base part may be configured to be slidably movable by being inclined forward or backward.

In addition, in the present specification, the technical terms of parallel, horizontal, vertical, upward, rectangular and the like do not necessarily mean geometrically complete parallel, horizontal, vertical and the like, respectively. The technical terms of parallel, horizontal, vertical, rectangular and the like may be interpreted to indicate generally (here, the term “generally” is interchangeable with other similar variations such as “substantially”) parallel, horizontal, vertical, rectangular and the like within a range such that the support equipment according to the present technology can be implemented without causing problems.

The meaning of the technical terms of parallel, horizontal, vertical, upward and the like may be in a range of approximately ±30° of geometrically complete parallel, horizontal, vertical, upward and the like.

Preferably, the meaning of the technical terms of parallel, horizontal, vertical, upward and the like may be of approximately ±20° of geometrically complete parallel, horizontal, vertical, upward and the like.

For example, the meaning of the technical terms of parallel, horizontal, vertical, upward and the like may be of approximately ±10° of geometrically complete parallel, horizontal, vertical, upward and the like.

As a concrete example, the rectangular may indicate that each angle of four corners of the rectangular is approximately 90°±10°.

Also, the rectangular may indicate that each side of the contour thereof may have a curved line without being restricted to a straight line.

Further, the slide base part (restricting part) may be configured to be detachable. In such a case, it is possible to provide a plurality of slide base parts capable of restricting the movement of the handle part between the sitting state and the standing state to different trajectories. Accordingly, the support equipment capable of making the handle part move between the sitting state and the standing state along a trajectory more suitable for the user can be realized.

The gripping portion of the handle part, the center of rotation R3, and the other end of the third link (link part) may not be arranged on a straight line. For example, the other end of the third link may be positioned rearward with respect to a straight line connecting the gripping portion of the handle part (for example, the farthest point from the center of rotation R3 in the handle part) and the center of rotation R3. The angle formed between a line connecting the gripping portion of the handle part and the center of rotation R3 and a line connecting the center of rotation R3 and the other end of the third link may be, for example, in a range of from 120° to 180°. In such a case, the third link may be formed into a linear shape, or it may be bent, for example, in a dogleg shape or generally L shape. Accordingly, it becomes possible to make the movement of the other end of the third link which is in association with the rotation of the second link (seat part) smoother.

As indicated in the first to third embodiments, it is possible to variously change the trajectory of movement of the gripping portion of the handle part between the sitting state and the standing state, for example, according to the shape of the elongated hole (guide trajectory) of the slide base part (restricting part). Therefore, a skilled person in the art may design the shape of the elongated hole (guide trajectory) of the slide base part (restricting part) in consideration of the posture of the handle part to be moved on the basis of the center of rotation R3, with respect to the handle part moving together with the center of rotation R3 of the second base. Even when the gripping portion of the handle part, the center of rotation R3, and the other end of the third link (link part) are not arranged on a straight line, it is possible to design the position and the shape of the elongated hole (guide trajectory) of the slide base part (restricting part) considering the posture of the handle part to be moved on the basis of the center of rotation R3, with referring to the disclosures of the present embodiments. For example, in a case when the other end of the third link (link part) is moved toward the center of rotation R3 as compared with the case when it is arranged on a straight line, the elongated hole illustrated in the first to third embodiments may be moved, in accordance with the moving amount, on the basis of the center of rotation R3.

With such a configuration, it is possible to realize a trajectory (or path) along which the height of the gripping portion of the handle part is not lowered, for example, during the course of the positional change from the sitting state to the standing state. During the course of the positional change from the sitting state to the standing state, it is possible to realize various trajectories: for example, a trajectory along which the gripping portion of the handle part is made to rise up at an early stage; a trajectory along which the gripping portion of the handle part is made to rise up at a later stage; a trajectory along which the gripping portion of the handle part is made to move linearly; and a trajectory along which the gripping portion of the handle part is made to move by drawing a gentle curve.

The shapes of the elongated holes (guide trajectories) of the slide base parts (restricting parts) on both left and right sides may be the same or different with each other. For example, the shapes of the elongated holes (guide trajectories) of the slide base parts (restricting parts) on both left and right sides may be changed so as to have different trajectories or postures of the handle parts on both left and right sides in association with movable conditions or force conditions of both shoulders or both arms of the user. In such a case, the slide base parts (restricting parts) on both left and right sides may be configured to be detachable independently of one another.

It is possible to prepare a set of a plurality of slide base parts (restricting parts) having the same or different shapes to be available for a piece of support equipment such that the slide base parts (restricting parts) can be used by various users having different physical constitutions and limb health conditions. The slide base part (restricting part) used for the support equipment of the present invention may be provided as a piece of slide base part (restricting part) or as a set of a plurality of slide base parts (restricting parts) having the same or different shapes. By attaching the slide base part (restricting part) to the main body part of the support equipment, it becomes possible to appropriately control the trajectory and the posture of the gripping portion of the handle part.

### REFERENCE SIGNS LIST

1, 201, 301 . . . Support equipment,
10 . . . Main body part,
11 . . . First link,
11A . . . First shaft portion,
111 . . . Knee rest,
12 . . . Second link,
12A . . . Seat surface,
12B . . . Bearing portion,
12C . . . Connecting shaft portion,
12D . . . Connecting portion,
12E . . . Connecting portion,
13 . . . Third link,
13A . . . Connecting hole portion,
13B . . . Engagement portion,
132 . . .Backrest,
132A . . . Linkage frame,
132B . . . Linkage portion,
132C . . . Linkage portion,
133 . . . Other end (which is a portion connecting the third link and the slide base part),
14 . . . Handle part,
15 . . . Passive actuator,
15A . . . Lever,
16 . . . Backrest support mechanism,
16A . . . Linkage portion,
16B . . . Linkage portion,
20 . . . Moving equipment,
21 . . . Base,
22 . . . Footrest,
33, 233, 333 . . . Slide base part,
33H, 233H, 333H . . . Elongated hole
41, 42 . . . Caster,
R1 . . . Center of rotation (of knee joint),
R2 . . . Center of rotation (of hip joint),
R3 . . . Center of rotation (on the second link of the third link),
R4 . . . Center of rotation (of the backrest support mechanism 16 with respect to the main body part 10), and
R5 . . . Center of rotation (between the backrest 132 and the backrest support mechanism 16).

1. A support equipment, comprising:
a base;
a first link fixed to the base;
a second link rotatably connected to the first link;
a slide base part fixed to the base at a position different from a position at which the first link is fixed to the base;
a third link having one end that is rotatably connected to the second link at a predetermined position, and another end that is slidably connected to the slide base part; and
a handle part fixed to the third link.

2. The support equipment according to claim 1, wherein the support equipment is capable of making a transition to a first position in which the second link is substantially parallel to the base, and to a position in which the second link is inclined at a desired angle with respect to the base

3. The support equipment according to claim 2, wherein the slide base part is configured such that one end of the third link is slidable in a uniaxial direction on the slide base part.

4. The support equipment according to claim 2, wherein the one end of the third link is rotatably connected to the second link 12 at one point, and the other end of the third link is slidably connected to the slide base part.

5. The support equipment according to claim 1, wherein the second link is provided with a seat surface, and is connected to the first link such that the second link can rotate about a first axis extending laterally at a front side of the second link,
wherein the third link is connected to the second link such that the third link can rotate about a second axis arranged behind the first axis, at a side of the second link,
wherein the handle part is connected to the one end of the third link, and
wherein the slide base part restricts movement of the other end of the third link to a predetermined range.

6. The support equipment according to claim 1, wherein the slide base part is configured to allow vertical movement of the other end of the third link and to restrict front-rear-direction movement of the other end of the third link.

7. The support equipment according to claim 1, wherein the slide base part is configured such that the other end of the third link moves upward as the other end moves forward.

8. The support equipment according to claim 5, wherein the slide base part is configured such that the other end of the third link moves along an upward-projecting trajectory.

9. The support equipment according to claim 5, wherein the slide base part is configured such that the other end of the third link moves along a downward-projecting trajectory.

10. A moving equipment, comprising:
the support equipment according to claim 1; and
wheels attached to the base.

11. A slide base part to be used in the support equipment according to claim 1.
